(19) United States
(12) Patent Application Publication
(10) Pub. No.: US 2014/0278647 A1
(43) Pub. Date: Sep. 18, 2014

(54) ENTITY MONITORING

(71) Applicant: Exterro, Inc., Tigard, OR (US)

(72) Inventors: Ganeshshankar C. Rameshkumar, Beaverton, OR (US); David Hartmann, Beaverton, OR (US); Biswajith Yarlagadda, Beaverton, OR (US); Ajith Samuel, Beaverton, OR (US); Jordan Drake, Beaverton, OR (US); Sathishprabhu Jayabal, Coimbatore (IN); Ganeshkumar Balusamy, Coimbatore (IN); Bobby Balachandran, Beaverton, OR (US); Karthik Palani, Beaverton, OR (US); Shashidhar Angadi, Beaverton, OR (US)

(73) Assignee: Exterro, Inc., Tigad, OR (US)

(21) Appl. No.: 14/212,039

(22) Filed: Mar. 14, 2014

Related U.S. Application Data
(60) Provisional application No. 61/800,629, filed on Mar. 15, 2013.
(60) Provisional application No. 61/920,911, filed on Dec. 26, 2013.

(51) Int. Cl. G06Q 10/10

(52) U.S. Cl. CPC G06Q 10/105
USPC 705/7.15; 705/320

(57) ABSTRACT

Embodiments are disclosed herein that relate to entity monitoring. In one example, a management system comprises a logic subsystem and a storage subsystem. The storage subsystem holds instructions executable by the logic subsystem to create an entity monitor based on user input, the input comprising a designation of an entity, at least one parameter associated with the entity, and at least one condition that defines a change in the at least one parameter, detect the change in the at least one parameter by accessing a storage device holding the at least one parameter, and responsive to detecting the change in the least one parameter, record the change in the at least one parameter in the entity monitor and execute one or more actions defined by the user input.

### CROSS REFERENCE TO RELATED APPLICATIONS

This application claims priority to U.S. Provisional Patent Application No. 61/800,629, entitled “ELECTRONIC DISCOVERY SYSTEMS AND METHOD,” filed Mar. 15, 2013, and to U.S. Provisional Patent Application No. 61/920,911, entitled “ENTITY MONITORING,” filed Dec. 26, 2013, the entire contents of both are hereby incorporated herein by reference for all purposes.

### BACKGROUND AND SUMMARY

Events such as a litigation or an internal company investigation frequently require that data associated with the event be made available. For example, electronically stored information (ESI) may be placed under a legal hold. In this example, compliance with the event may require that ESI be produced at a later time without undergoing spoliation. However, a variety of factors may increase the difficulty of complying with the event, as changes to ESI and entities associated with ESI may frequently occur. For example, employees associated with ESI may be terminated, resign, or move among departments, and storage media holding ESI may fail and be replaced. These issues are exacerbated as the size of ESI and number of associated entities increase, which may require burdensome effort to ensure compliance.

In some approaches, changes to entities associated with ESI are manually tracked to ensure that the ESI is properly preserved. For example, human resource data may be manually consulted on a periodic basis to discover changes in employment status. ESI associated with entities whose employment status has undergone change is then discovered, and appropriate action is taken to ensure preservation of the ESI. However, the manual correlation of entity changes to ESI is error-prone, time-consuming, and costly. Spoliation of ESI can thus result.

Embodiments are disclosed herein that relate to monitoring entity changes and automatically taking appropriate action in response. For example, one disclosed embodiment provides a method of monitoring an entity on a computing device, the method comprising creating an entity monitor based on input supplied by a user, the input comprising a designation of the entity, at least one parameter associated with the entity, and at least one condition that defines a change in the at least one parameter. The method further comprises detecting the change in the at least one parameter by accessing a storage device holding the at least one parameter, and, responsive to detecting the change in the at least one parameter, recording the change in the at least one parameter in the entity monitor, and executing one or more actions defined by the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an exemplary system configured to facilitate entity monitoring.

FIGS. 2A-C show a flowchart illustrating an exemplary method of monitoring an entity.

FIGS. 3A-AI show aspects of exemplary application configured to facilitate entity monitoring and other functions.

### DETAILED DESCRIPTION

As described above, an event may occur that requires data to be preserved and subsequently produced without undergoing spoliation. The event may be a legal hold resulting from litigation, a regulatory compliance request, or an internal company investigation, for example. A multitude of factors may increase the difficulty of producing the data without spoliation and complying with the event, however. For example, employees that possess electronically stored information (ESI) or are otherwise associated with the ESI may be terminated or move to another department. Moreover, ESI may be transferred among storage media or deleted as part of a scheduled process.

In some approaches, human resource data is manually consulted to discover changes in employment status. ESI associated with employees whose statuses have changed is then discovered, with appropriate action taken to ensure its preservation. However, such a manual process is error-prone, time-consuming, and costly, and can result in spoliation of ESI.

Accordingly, various embodiments are disclosed herein that relate to entity monitoring. In one example, a management system comprises a logic subsystem and a storage subsystem. The storage subsystem holds instructions executable by the logic subsystem to create an entity monitor based on user input, the input comprising a designation of an entity, at least one parameter associated with the entity, and at least one condition that defines a change in the at least one parameter, detect the change in the at least one parameter by accessing a storage device holding the at least one parameter, and responsive to detecting the change in the least one parameter, record the change in the at least one parameter in the entity monitor and execute one or more actions defined by the user input.

As used herein, an “entity” refers to that which may be associated with ESI, and may include storage media holding ESI (e.g., a “data source”), collections of records (e.g., matters), end users, employees, and companies or other institutions that create, access, modify, or are otherwise associated with ESI.

FIG. 1 schematically shows a system 100 that may facilitate the creation, storage, modification, access to, and deletion of ESI. Although system 100 is described herein with respect to a limited number of devices and a single network, one of ordinary skill in the art will recognize that a system containing ESI may include different numbers of components and other types of components than those shown. The system components may be standalone or may be interconnected by one or more networks of various types. Further, the devices in system 100 may include suitable logic and/or storage devices not shown, examples of which are described below.

The devices in system 100 are communicatively coupled to one another via a network 101, which may be any suitable type of network including but not limited to a local area network (LAN), wide area network (WAN), intranet, internet, WI-FI, cell phone network, cloud network, or any other wired or wireless network configured for communication among computing devices. Network 101 may implement various suitable security measures, such as a firewall. As described below, network 101 may facilitate searches and other actions relating to ESI on the devices connected to the network.

System 100 of FIG. 1 is provided as a non-limiting example for explanation purposes. System 100 includes client computing devices 102 and 104, which may be operated by one or more custodians. “Custodian” as used herein refers to a user who is in some way associated with ESI and may be responsible for its procurement upon request. A group of custodians may be employees of a company or other institution, for example.

System 100 further includes server computing devices 106 and 108, which may provide various functionalities to client computing devices 102 and 104 and networked devices and users. Server computing devices 106 and 108 may be any suitable types of server computing devices, including but not limited to file servers, collaboration servers, and email servers.

System 100 also includes storage devices 110 and 112, which may be configured to store facilitate access to ESI via computing devices 102, 104, 106, 108, and other networked computing devices. Each of storage devices 110 and 112, in addition to other devices in system 100 that hold ESI, may be generally referred to herein as a “data source”, and may include any suitable storage media including but not limited to hard disk drives (HDDs), optical drives (e.g., CD, DVD, Blu-Ray), and tape drives. In some embodiments, one or both of storage devices 110 and 112 may be ESI vaults configured to store ESI whose spoliation is to be prevented.

Still further, system 100 includes a human resource (HR) store 114 configured to store human resource data regarding entities such as individual custodians. HR data associated with a given custodian may include their name, address, title, organizational position, employment status (e.g., employed, terminated, resigned, etc.) and other biographical and employment information. By regularly accessing HR store 114, appropriate action may be automatically taken upon detecting changes in these and other entity parameters. As one non-limiting example, a custodian profile stored on HR store 114 may include the employment status of a given custodian, allowing ESI-preserving actions to be automatically executed upon detection that their employment status has changed to terminated.

System 100 further includes third-party systems 115, which may include a variety of software and hardware generally related to ESI. For example, third-party systems 115 may include third-party electronic discovery reference model (EDRM) tools, matter management systems, active directory (AD), and lightweight directory access protocol (LDAP). Third-party systems 115 may smoothen interaction among disparate users and groups (e.g., information technology (IT) and legal departments), for example.

System further includes internal/legacy systems 116, which may facilitate functionality specific to particular organizations or departments, and may include relatively older hardware and/or software modules.

System 100 also includes enterprise management system 118, which includes a plurality of software routines or modules 120 configured to facilitate the approaches described herein, which may generally include automatic execution of one or more actions in response to detection of a change in one or more parameters associated with an entity. With modules 120, system 100 may be further configured to facilitate data visualization, legal holds, e-discovery, project management, data mapping, and data review and analysis, for example. The facilitation of such processes may include interfacing with other applications, systems, and devices. Moreover, the plurality of modules 120 may interface with one another to expand the functionality of enterprise management system 118. A method 200 shown in FIG. 2 and various graphical user interfaces (GUIs) application shown in FIGS. 3A-AI, both described below, illustrate how enterprise management system and its modules may be applied.

It will be appreciated that enterprise management system 118, along with the plurality of modules 120, may be implemented on a single computing device. For example, the plurality of modules 120 may be implemented as instructions stored in a non-transitory storage medium 119A (e.g., a storage subsystem) and executed by a processor 119B (e.g., a logic subsystem). Storage medium 119A and processor 119 may comprise two or more storage mediums and two or more processors, respectively. In particular, storage medium 119A may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium 199A may include volatile, nonvolatile, dynamic, static, read/write, read-only, random-access, sequential-access, location-addressable, file-addressable, and/or content-addressable devices.

In other embodiments, however, enterprise management system 118 may be implemented on two or more computing devices (e.g., devices in system 100) with the plurality of modules 120 distributed among such multiple computing devices.

The plurality of modules 120 includes an entity manager 122 configured to store a plurality of entity profiles 124 (e.g., entity profile 124A-N). A given entity profile 124 may store data relating to custodians, data sources, groups of users, a company, a record, or a user-defined object, for example. Entity profiles 124A-N may be, in part, constructed based on data retrieved from HR store 114. As with HR store 114, entity profiles 124 may be monitored to detect changes in parameters stored therein, which may facilitate the automatic execution of actions in response to the detected changes. As a non-limiting example, an entity profile for a record may store a scheduled date of an interview to be conducted as part of an effort to discover ESI relevant to an internal company investigation. In response to detecting that the scheduled date is near, enterprise management system 118 may automatically output notifications reminding key participants to conduct the interview.

The plurality of modules 120 further includes a data mapping module 126 configured to amass a map of ESI stored on the devices in system 100, such as data map 128. The mapped ESI may be stored in any suitable data structure such as a database, for example, and may be stored on a suitable storage medium, such as storage devices 110 and/or 112 or a storage device included in enterprise management system 118 (not shown). A constructed map may be searched for ESI using a wide variety of user-specified criteria that may include searches of file contents as well as associated metadata. For example, a user may search a data map for ESI by specifying file owners and/or authors (which may be cross-referenced with HR store 114, for example), creation and/or modification dates, among other search criteria. Data mapping module 126 may include a search module (not shown) to facilitate such search functionality, or searches may be implemented in a dedicated search module (not shown) in the plurality of modules 120.

The creation and maintenance of data maps may help end users to ascertain the types and volume of data for a given data set, the storage and computing devices associated with the data, and its ownership. The burden of some tasks such as e-Discovery and early case assessment may be reduced via data maps, for example. When combined with other modules and features described below, the power afforded by data mapping may be expanded—for example, changes to a data map may be tracked over time and displayed in a variety of multidimensional manners, allowing data change, propagation, ownership, and even custodian behavior and interaction through data analysis to be visualized.

As changes to mapped data may occur frequently, data maps may be regularly refreshed (e.g., updated). In some embodiments, data map refreshes may be manual and user-initiated. In other embodiments, data map refreshes may automatically occur with a predefined frequency and/or in response to detection of a change in a parameter associated with an entity—for example, detection of a change in entity profile 124A in entity manager 122 or in a custodian profile in HR store 114. Refreshing data maps in this way may allow users to respond proactively to frequent changes in data.

The plurality of modules further includes a project management module 130 configured to assist in the creation, modification, management, and completion of projects (e.g., projects 132A-N), among other functions. “Project” as used herein generally refers to a set of activities, often performed collaboratively by a plurality of users, to effect a desired outcome. As non-limiting examples, a project may relate to e-Discovery, legal holds, investigations, etc.

Project management module 130 may facilitate the creation of configurable questionnaires and other templates, which in some scenarios may be reused to reduce work and errors via standardization. Templates, as well as project settings which may control how users participate in a project and/or interact with enterprise management system 118, may be saved in projects 132 for subsequent use. For example, project management module 130 may create at least a portion of an electronic interview from a standard template saved in project 132A, in response to a legal hold being applied to a set of data. The interview may be completed with other user-supplied input and sent to the relevant user(s) and conducted in any suitable manner—for example, via a series of questions presented via the users' email application.

Project management module 130 may assist with advancing and completing projects in other ways. For example, project management module 130 may manually and/or automatically build project plans that enforce compliance by assigning tasks, output notifications (e.g., via SMTP email integration), execute automated processes, track and seek approvals, and enforce schedules. Moreover, project management module 130 may assist in constructing relationships among entities, projects, ESI, and other elements—for example, the project management module may link relevant records to one another.

The plurality of modules 120 further includes a visualization module 134 configured to facilitate visual interaction between users and enterprise management system 118. In some embodiments, visualization module 134 may present a graphical user interface (GUI) application configured to facilitate the approaches described herein. An example of the GUI application is shown and described below with reference to FIGS. 3A-AI. Generally, visualization module 134 may visually present information regarding entities, which may include indications of change, trends, correlation and other relationships. Mechanisms for visualizing and filtering entity information may further be provided.

In one example, the GUI application may be used as a platform to present a homepage to users that conveys the status and progress of a project (which may involve cross-referencing with project management module 130), the extent of custodian compliance, lists of implicated custodians, active legal holds, and notifications. The homepage may include other information such as a timeline indicating important events and an indicator that tracks progress of a typical EDRM process involving one or more of the following stages: identification, preservation, collection, processing, review, and production. In some embodiments, the contents of a homepage may be adjusted by its associated user. An example homepage is shown and described below with reference to FIG. 3AY. More generally, visualization module 134 may interface with other modules in the plurality of modules 120 to provide visualization and other functions.

The plurality of modules 120 further includes a legal hold module 136 configured to enforce holds on ESI distributed across system 100. Typically, a legal hold involves a thorough search of electronic media for ESI relevant to the hold. To comply with the hold and avoid data spoliation, legal hold module 136 may prevent relevant ESI from being deleted or otherwise modified, which may include adjusting file modification policies associated with the ESI and suspending deletion on an email server, for example. Legal hold module 136 may interface with entity manager 122 and data mapping module 126 to ensure that the correct ESI is placed under hold. As one non-limiting example, data associated with a custodian is placed under a hold (e.g., due to a change in the employment status associated with the custodian) and accordingly is copied to an ESI vault (e.g., storage device 110) where the data stored at the ESI vault is prevented from being deleted or otherwise modified. In some scenarios, access to all data belonging to the custodian and stored in the ESI vault may be provided, for example, upon detection that the custodian has been terminated.

Custodians may or may not be made aware that ESI modification and/or deletion is being prevented, as, in some examples, custodians may perceive successful modification and/or deletion of ESI event when, in actuality, they are prevented from doing so by legal hold module 136. Moreover, legal hold module 136 may control whether a hold is published or non-published—in other words, whether a custodian implicated in the hold is aware of the hold or not, respectively.

Legal hold module 136 may also aid in enforcing compliance when action from users is required. For example, legal hold module 136 may require custodians to acknowledge a hold, confirm their understanding of the hold, and in some scenarios facilitate communication with legal personnel for clarification. To carry out this functionality, legal hold module 136 may interface with project management module 130 to output notifications to users. As such notifications are sent from a single, common platform (e.g., enterprise management system 118), hold compliance may be improved by standardizing the format and contents of notifications. It will be appreciated, however, that acknowledgement of a hold may be facilitated by a third party user—for example, via third party systems 115. In this case, the acknowledgement may be considered a “proxy” acknowledgement used for scenarios in which custodians are unable to provide acknowledgement themselves. Legal hold module 136 may also interface with project management module 130 to drive interview participation—for example, to assign and conduct electronic interviews as part of a legal hold.

The plurality of modules further includes a monitor module 138 configured to assist in the creation, modification, and management of monitors (e.g., monitors 138A-N), among other functions. “Monitor” as used herein generally refers to a mechanism used to monitor entities and to detect changes to parameters associated with the entities, for example by detecting changes in entity profiles 124 in entity manager 122. Conditions may define scenarios in which actions are taken in response to changes to parameters associated with an entity. Entities, parameters, conditions, and actions may be defined by a user during monitor creation. Monitor module 138 may also implement a monitor log that records user-driven events that occur during a monitor's existence. Events recorded in the monitor log may be presented via a monitor console, which may display content in a typical console format and may be visually presented to users via visualization module 134, for example. A variety of data may be associated with an event, including but not limited to details of the event, the date and time of their occurrence, and username(s) of the user(s) who initiated the event. An example method 200 that be used to create an entity monitor is shown and described below with reference to FIG. 2, while an example GUI application 300 operable to create entity monitors is shown and described below with reference to FIGS. 3A-AI.

Finally, the plurality of modules 120 also includes a predictive intelligence module 140 configured to employ predictive technologies to prioritize ESI distributed throughout system 100 for manual review. Accordingly, the cost of manual reviews of ESI that has already been prioritized may be reduced. Predictive intelligence module 140 may be applied in other scenarios, for example to anticipate e-Discovery requests.

FIG. 2 shows a flowchart illustrating a method 200 of monitoring an entity. More specifically, method 200 may be executed to create a monitor to detect a change in a parameter associated with an entity and automatically execute one or more actions in response. Method 200 may be stored as machine-readable instructions in enterprise management system 118 and executed thereon, for example, and may involve accesses to the devices on system 100 on FIG. 1. In some embodiments, method 200 may be implemented in a GUI application to facilitate entity monitor creation, as shown described below with reference to FIGS. 3A-AI.

At 201 of method 200, event logging in a monitor log is initiated. Specifically, events that are user-driven and that occur during the existence of the monitor are recorded in the monitor log. The monitor log may be visually presented via visualization module 134, for example. Initiation of event logging at 201 may include recording the creation of the monitor in the monitor log.

At 202 of the method, information regarding an event to be monitored is received. The event information may be supplied by a user via client computing device 102 on network 101, for example. The event information (or, more generally, monitor information) may include information regarding the creator of the monitor (e.g., the user), such as their name, contact information (e.g. email, telephone number, etc.), title, and associated institution (e.g., company name). The event information may further include a description of the monitor and the names of one or more optional approvers, which in some examples may be organizational superiors to the monitor creator. As described in further detail below, specification of one or more approvers may cause the monitor to determine if approval has been granted by the one or more approvers before the certain functionalities of the monitor are carried out. In some embodiments, the reception of event information may be followed by access to HR store 114 such that the information supplied by the monitor creator may be positively cross-referenced to users and HR data stored therein.

Receiving the event information may include receiving a designation of an entity to be monitored at 204. The entity may be specified in any suitable manner, such as by first and last name, a unique string identifying the employee, or other criteria residing in entity profiles 124 in entity manager 122.

Receiving the event information may further include receiving a designation of an event to be monitored at 206, which may include creation of a new custodian, a change in information associated with an existing custodian, deletion of a custodian, addition of a data source (e.g., addition of a new HDD to client computing device 102 in FIG. 1), a change in information associated with a custodian data source (e.g., the status of a data source becoming inactive due to repairs or configuration changes to the data source, a change in a username and/or password associated with the data source, migration from an application to a newer version of the application, etc.), and deletion of a custodian data source (e.g., reformat or removal from a client computing device). The aforementioned changes to a data source may be referred to as a “modification” of the status of the data source. As described in further detail below, detection of these events may include accesses to HR store 114, entity manager 122, client and server computing devices, and other devices in system 100.

Still further, receiving the event information may include receiving at least one parameter associated with the entity at 208, whose change will be monitored in order to drive automatic execution of one or more actions responsive to the change. As a non-limiting example, event information indicating that a change in a custodian's information should be monitored is received. The custodian information is stored and accessed in entity manager 122, for example. Accordingly, the parameters associated with the custodian whose change may be monitored include company name, country, first name, last name, employee ID number, email address, etc., though additional parameters are possible. It will be appreciated that, in some embodiments, multiple entities, events, and/or parameters may be received at 202. In other embodiments, only one monitor per entity may be created.

Next, one or more conditions regarding the event and one or more parameters are received at 210. Specification of one or more conditions may allow execution of one or more actions responsive to detection of a change in at least one parameter associated with an entity to be contingent on such detection. In particular, the one or more conditions may define relationships among the entity, parameter(s), and one or more values via operators. The operators may include equal to, not equal to, contains, does not contain, is null, is not null, starts with, and ends with operators. As one non-limiting example, two conditions may be defined as part of the creation of a monitor: first, that the company name associated with a custodian is equal to a predetermined string (e.g., an entity name retrieved from entity manager 122), and second, that the employment status of the custodian is equal to terminated (where employment statuses are also retrieved from entity manager 122, for example).

In some embodiments, receiving one or more conditions at 210 may be optional. In this example, one or more actions may be executed not in response to the satisfaction of one or more conditions, but based on the information received at 202. For example, a change of any kind in the one or more parameters received at 208 may cause execution of the one or more actions. If, however, one or more conditions are received, they may be recorded in the monitor log.

Next, one or more actions to be executed in response to satisfaction of the one or more conditions (or upon any change in the one or more parameters should conditions not be specified) are received at 212. The actions may be logged in the monitor log. Receiving the one or more actions may include, at 214, receiving one or more tasks. “Tasks” as used herein refer to actions that may be assigned to users (including the monitor creator) that create an obligation for the assignee(s) to comply with. During task creation, the monitor creator may specify a variety of information, including but not limited to task name, task type (whether the task is a common task for all assignees, an individual task for each assignee, one task per matter, one task per matter team, one task per legal hold, or one task per interview), assignees (individual users or groups of users including those that may be retrieved from HR store 114 and/or entity manager 122), task description, task subject, and a task notification that, if included, is outputted following task creation, described in further detail below. In some embodiments, groups of users to which tasks may be assigned may be defined by the monitor creator. For example, the monitor creator may create user groups for IT personnel, legal counsel, interview officers, etc. such that tasks may be collectively assigned to defined groups and roles.

Receiving the one or more actions may include, at 216, receiving one or more processes to be executed upon satisfaction of the one or more conditions (or upon any change in the one or more parameters should conditions not be specified). “Process” as used herein generally refers to an action that is automatically carried out and that does not require user action following creation of its associated monitor. Such processes may include a scope process operable to discover custodians relevant to a matter, an add process operable to associate custodians to a matter, and a remove process operable to dissociate custodians from a matter. The processes may further include an issue legal hold process operable to apply a legal hold to custodians, an escalate legal hold process operable to escalate a legal hold to the supervisor(s) of custodians, a release legal hold process operable to release and dissociate a legal hold from custodians, and processes operable to change the status of a legal hold associated with a given custodian with or without notifying the custodian. For example, the monitor creator may choose processes such that a custodian is released from a legal hold without his or her knowledge. Additional example processes are possible.

As with tasks above, the monitor creator may specify a variety of information during process selection, including but not limited to process name, process type, assignees, process description, process subject, and a notification to be outputted upon execution of the process, which are analogous to their task counterparts described above.

Receiving the one or more actions may include, at 218, receiving one or more notifications to be outputted. The notifications may include task notifications that notify users of the assignment of tasks automatically upon their assignment. Task notifications may be received concurrently with the reception of other task information at 214, for example. Alternatively or additionally, the notifications may include process notifications that notify users of the execution of processes automatically upon their execution. Process notifications may be received concurrently with the reception of other process information at 216, for example. The notifications may also include notifications not associated with tasks or processes, and in some scenarios may include such non-associated notifications and not tasks or processes. For example, a monitor creator may create a monitor that outputs a notification to an organizational superior to conduct an exit interview upon detection that a subordinate's employment status has changed to resigned, but that does not assign tasks or perform processes.

Notifications may include text encoded in ASCII or UTF-8, for example, and in some embodiments may include multimedia such as audio, images, video, etc. Notifications may be outputted in various suitable manners, for example via visualization module 134. Alternatively or additionally, notification output may be tailored to the network(s) to which the system executing method 200 are connected. For example, the method may leverage an existing email server to push notifications.

Next, at 220, the execution of the one or more actions received at 212 is scheduled based on input supplied by the monitor creator. The schedule may be recorded in the monitor log. Scheduling the one or more actions may include, at 222, scheduling the one or more actions to execute as and when the event defined at 206 occurs, according to the satisfaction of one or more conditions, were they received at 210. As one non-limiting example of this schedule type, a monitor is created in which an event is defined as a change in the employment status of a given custodian. No conditions are defined, but an automatic backup process is specified in which a storage device associated with the custodian is automatically imaged upon detecting this change in employment status.

Alternatively, the one or more actions may be scheduled for execution on a periodic basis defined by the user at 224. The periodic schedule may be hourly, daily, weekly, monthly, or yearly for example, or may be defined on a more granular basis such that specific date ranges and times may be selected as part of the monitor schedule.

As another alternative, the one or more actions may be scheduled as synchronization with an HR system occurs at 226. The HR system may be HR store 114 of FIG. 1, for example, and may store a plurality of user profiles (e.g., custodian profiles) along with one or more associated parameters such as employment status. In this way, the one or more actions received at 214 may be automatically executed in response to detection of a change in a parameter associated with a custodian.

Selection of the above schedules at 222, 224, and 226 may form part of the creation of what is referred to herein as an “automatic” entity monitor. An automatic entity monitor is one that, depending on the satisfaction of its events and/or conditions, automatically executes one or more actions according to a user-defined schedule. In contrast, the monitor may instead not be scheduled at 228. In this example, the resultant monitor is referred to herein as a “manual” entity monitor. A manual entity monitor is one having actions that, to be executed, must be manually prompted by a user. Thus in some examples, the one or more actions will execute each and every time they are prompted to do so.

Next, at 230, it is determined whether approval for the monitor is required. As described above, reception of event information at 202 may include reception of one or more monitor approvers. In some embodiments, selection of one or more monitor approvers by the monitor creator may cause the monitor to be saved in what is referred to herein as a “suspended” state once the event information, conditions, actions, and schedule have been received. In this suspended state, even if the event and conditions are satisfied, the actions will not execute, as approval of the monitor has not been granted. Selection of one or more monitor approvers may allow proactive action to be taken in response to a change in a user or custodian parameter, while respecting organizational and legal practices. As with task assignees described above, one or more than one approver may be selected, including groups of approvers.

If it is determined that approval for the monitor is not required (NO), the method proceeds to 238. If, on the other hand, it is determined that approval for the monitor is required (YES), an approval request is outputted at 232. The approval request may include a summary of the monitor (e.g., entity, event, parameters, conditions, tasks, processes, notifications, etc.) and requires that feedback be provided from the approver—namely, approval or denial of the monitor. As described above with notifications, the approval request may be outputted in various suitable manners such as in a GUI application shown in FIGS. 3A-AI that provides a common interface for monitor creation and other monitor interaction such as monitor approval. In some embodiments, the approval request is presented in the form of an email that includes buttons with which approvers may interact to approve or deny the request.

At 234, it is determined whether approval for the monitor has been received. As shown, if it is determined that approval has been received (YES), an approval notification is outputted at 236. As with notifications described above, the approval notification may be output in various suitable manners, and is sent at least to the monitor creator to notify him or her of the approval. If approval has not been received (NO), the method returns to 234. In alternative embodiments, if approval has not been received (NO), additional action may be taken after a threshold time, such as sending an additional approval request and/or a notification to the monitor creator that approval has not yet been granted. If approval has been denied (DENIED), the method ends. At this point, the monitor creator may begin the monitor creation process again at 202. In some embodiments, a denial notification is outputted to the monitor creator, and may indicate particular settings of the monitor that are denied. In this example, the monitor creator need only edit those settings that have been denied, as the denied monitor and its settings have been saved.

At 238 it is optionally determined whether the monitor has been activated. In some embodiments, even after a monitor has been successfully completed and submitted (and having approval if required), its status may be set to suspended such that even if its event and condition(s) are satisfied, its actions will not be executed. A monitor's default status (e.g., whether it is activated or suspended following its completion) may be one of a plurality of policies set by a user having sufficient privileges that govern monitor creation and behavior. If it is determined that the monitor has been activated (YES), the method proceeds to 240. If it is determined that the monitor has not been activated (NO), the method returns to 238.

At 240, it is determined whether a trigger of the monitor has occurred. A trigger encapsulates the event, parameter(s), and condition(s) that define the contingent execution of a monitor's action(s). The trigger occurs when these conditional aspects of the monitor are satisfied. To detect the occurrence of a trigger, systems to which the device executing method 200 are communicatively coupled are persistently accessed, which may be on a periodic basis whose frequency may be adjusted according to hardware and software constraints. As a non-limiting example, a monitor is created whose event is the deletion of a custodian data source. The conditions include the parameter custodian data source type being equal to a laptop computing device, and the parameter last name of the custodian being equal to “Smith”. To detect the occurrence of this trigger, data map 128 of enterprise management system 118 is accessed daily, for example.

If it is determined that the monitor trigger has occurred (YES), the method proceeds to 242. Trigger occurrence may be recorded in the monitor log. If it is determined that the monitor trigger has not occurred (NO), the method returns to 240 in order to enable persistent trigger detection. As described above with reference to step 234 of the method, the method may include additional steps not shown if the trigger has not occurred, such as outputting a notification to the monitor creator and optionally organizational superiors conveying that the trigger has not occurred.

Next, at 242, one or more actions are executed. Execution of the one or more actions may include, at 244, assigning one or more tasks. As described above, tasks are actions that require input from the users to which they are assigned. Tasks may be assigned to individual users, or any suitable groups of users including roles; for example, a task may be commonly assigned to all paralegals for a given institution. Task assignment at 244 may include accesses to HR store 114 and/or entity manager 122, for example, and may be recorded in the monitor log. A plurality of tasks may be assigned that, depending on the context of their assignment, may facilitate portions of entity monitoring, e-Discovery, regulatory compliance requests, internal company investigations, and other workflows. Non-limiting examples of tasks include the assignment of custodian interviews, questionnaires, surveys, and data map refreshes (e.g., assigning a user to update data map 128).

Execution of the one or more actions may further include, at 246, executing one or more automated processes. The one or more automated processes may be recorded in the monitor log. A plurality of automated processes may be utilized that leverage the functionality of the device (e.g., enterprise management system 118) executing method 200 as well as the devices operatively coupled to the device (e.g., the devices connected to network 101), and may implement at least a portion of a typical EDRM process. For example, the set of available automated processes may include identification processes such as a data map refresh process in which a data map (e.g., data map 128) is automatically updated. The automated processes may further include preservation processes such as a hold process in which data identified in a legal hold is locked down—that is, the data may be prevented from being deleted or otherwise modified. In some examples, such data may reside on a custodian data source (e.g., laptop), while in other examples the data may reside on an email server. In some embodiments, custodians who possess locked down data and attempt to delete it may perceive the deletion to be successful when it is in fact prevented.

The automated processes may further include collection and processing processes, some of which may be combined as combined collection and processing processes. As one non-limiting example, data placed under a legal hold is identified as residing on a custodian data source. However, a significant portion of data on the custodian data source is irrelevant to the legal hold, such as operating system files and duplicate files. Accordingly, the combined collection and processing process may access the custodian data source, identify and cull the relevant data, and then copy the culled, relevant data to an ESI vault (e.g., storage device 110 in FIG. 1) for preservation. Such a combined collection and processing process may be advantageous compared to other processes in which a custodian data source is copied in its entirety to a storage medium and then culled at the storage medium. In some embodiments, the collection and processing processes may interface with third-party systems (e.g., third-party systems 115) including but not limited to data preservation, archiving, and collection systems.

Still further, the automated processes may include analysis processes that provide search, textual, and predictive analytics. For example, a plurality of custodian data sources may be searched and analyzed to identify data that is potentially relevant to a legal hold and further to prioritize the potentially relevant data for subsequent manual review. Such processes may utilize predictive intelligence module 140 of FIG. 1, for example, and may reduce the difficulty of analyzing large volumes of data.

Yet further, the automated processes may include interview processes in which interviews are outputted to relevant users. For example, a custodian associated with an active legal hold may leave a company. In response, the legal team associated with that company may configure a monitor to automatically issue and assign an interview to a supervisor of the custodian, seeking details regarding the custodian's access to ESI, its recovery status, and other physical and/or electronic data that may be relevant to the legal hold.

Execution of the one or more actions may further include, at 248, outputting one or more notifications. The notifications may or may not accompany tasks and/or automated processes.

At 250, following execution of the action(s) at 242, data regarding the trigger occurrence is recorded. Such trigger data may be recorded in a monitor console and displayed in a GUI application, shown and described in further detail with reference to FIG. 3. The trigger data may include a list of records impacted by the trigger occurrence, including records that have been modified as a consequence of action execution at 242 and records that have not been modified as a consequence of action execution but that are implicated after trigger occurrence. “Record” as used herein refers to a collection of data that encapsulates information regarding an entity being monitored, and may include, for example, an alphanumeric identifier, associated custodian name(s), associated data source(s), dates of modification, the identity of the associated monitor creator, etc. Generally, a record provides an easily digestible mechanism for visualizing monitored entities. A record and its associated data may be presented in the GUI application shown and described below with reference to FIGS. 3A-AI.

The trigger data may further include a list of the action(s) executed at 242 and their times of execution, lists of “open” action(s) (e.g., action(s) that are not yet fully completed) and “completed” action(s) (e.g., action(s) that have been fully completed). The action(s) lists may include data regarding assignee(s), their status (e.g., open, completed, level of completion), records that they individually impact or implicate, and tasks that are open (e.g., still require further user action).

It will be appreciated that, in some scenarios, the monitor may not be scheduled at 228, in which case the one or more actions will not automatically execute at 242 upon trigger occurrence. Nevertheless, entity monitoring will continue as will trigger detection. Trigger occurrence and associated data (e.g., time of occurrence, associated custodians and data sources, implicated records, etc.) may be recorded in the monitor log.

Turning now to FIG. 2C, at 252 of method 200, it is determined whether an action status of the monitor has changed. In some embodiments, a single action status may be associated with the monitor and encapsulate the statuses of all actions of the monitor. In other embodiments, an action status may be associated with each action of the monitor. Such association of action status with actions may be a policy set by the monitor creator or other user.

If it is determined that the action status has not changed (NO), the method proceeds to 254 where it is determined whether a threshold time has elapsed. The threshold time may be any suitable time interval (e.g., one day) and may be an adjustable policy set by the monitor creator or other user. If it is determined that the threshold time has not elapsed (NO), the method returns to 252. If it is determined that the threshold time has elapsed (YES), the method proceeds to 256 where a compliance notification is optionally outputted. In scenarios in which at least one task was assigned to a user at 244, the compliance notification may remind the assignee to complete the task, and may summarize the content of the task and any relevant information (e.g., information derived from associated records). Additionally, the at least one task may be optionally escalated to one or more other users at 257, who may be organizational superiors to the assignee. Following 257, the method returns to 252.

If, at 252, it is determined that the action status has changed (YES), the method proceeds to 258 where a status notification is outputted. The status notification may convey the new action status, in addition to other information such as the previous action status, current completion level of all tasks, etc.

Next, at 260, the action status is determined. It the action status is determined to be cancelled (CANCELLED), the method proceeds to 262 where a cancellation notification is outputted. Here, at least one user to which a task was assigned has chosen to cancel the task. Task cancellation may be performed in the GUI application shown and described with reference to FIGS. 3A-AI, for example. If the action status is instead determined to be completed (COMPLETED), the method proceeds to 264 where a completion notification is outputted. Here, at least one user to which a task was assigned has completed the task and changed its status to completed.

Next, at 266, it is determined whether the status of all tasks assigned at 244 is completed. If all tasks are not completed (NO), the method returns to 252, and may do so iteratively until the status of all tasks is completed. This may occur, for example, in scenarios in which multiple tasks have been assigned that each have an associated action status. If all tasks are completed (YES), the method proceeds to 268. In some embodiments, the method may further verify at 266 that all notifications have been outputted and all automated processes have been executed.

Next, at 268, it is determined whether the monitor has been suspended. Suspension of the monitor may be carried out by the monitor creator, for example, and may be done so upon completion of the action(s) executed at 242 or at another desired time (e.g., expiration of a legal hold that prompted creation of the monitor). If the monitor has not been suspended (NO), the method ends. If the monitor has been suspended (YES), the method proceeds to 270 where a suspension notification is outputted, conveying the suspended status of the monitor. The suspension notification may be outputted to the monitor creator and all implicated custodians (e.g., custodians to which task(s) were assigned), for example. It will be appreciated, however, that the locations of steps 268 and 270 are provided merely as examples and are not intended to be limiting; determination of monitor suspension in some embodiments may be a persistent check that is executed regularly throughout method 200.

Thus, as shown and described, method 200 may facilitate portions of a typical EDRM process, as well as other processes such a regulatory compliance investigation, and an internal company investigation. Further, multiple users who have a plurality of different roles in an organization may contribute to such processes, reducing disproportionate reliance on certain key organizational members such as IT or legal personnel. Method 200 also facilitates such processes in an end-to-end, unified manner in which adjacent stages are linked to each other. In contrast to other more disjointed approaches, method 200 may reduce redundancy, time, errors, and data spoliation.

The approaches described herein, including that of method 200, may be extended to virtually any context in which entity parameters may be tracked and monitored. To enable the creation of custom workflows, users possessing appropriate credentials may customize and create their own entities, parameters, conditions, and actions to create custom entity monitors. As a non-limiting example, method 200 may be implemented in a government context in which the monitored entities are government agencies. In this example, the budget of each agency is monitored, and, when exceeded, causes the automatic assignment of an interview task to users in order to initiate a budgetary review process. As another non-limiting example, students in a school comprise the monitored entities. When the tardiness of a student exceeds a certain value, a detention is automatically assigned to that student. As yet another example, monitors may be used in an information governance (IG) setting. Here, records may be retained for a predetermined retention period. When this period is exceeded, users who manage the records may be automatically notified to dispose of the exceeding records and/or to review retention policies. The customization of workflows and entity monitors may be limited only by the extent to which entities and associated parameters may be tracked.

These and other non-limiting examples of applications of method 200 generally illustrate the advantages inherent to taking automatic action in response to monitoring entity parameters. By eliminating some of the dependency on manual, human input, actions may be taken with less time, cost, and error, which may prove significantly advantageous in settings in which high-value ESI and/or entities is handled.

FIGS. 3A-AI illustrate an example GUI application 300 in which method 200 may be implemented to facilitate the above-described and other processes—e.g., e-Discovery, regulatory compliance, internal company investigations, etc. Application 300 may further facilitate the creation of custom workflows and entity monitors in a variety of contexts. Application 300 may be executed on client computing devices 102 and 104, and may include data storage and/or retrieval with storage devices 110 and 112, HR store 114, entity manager 122, enterprise management system 118, internal/legacy systems 116, and third-party systems 115, for example.

Before application 300 is described, an example set of users participating in the creation and use of a monitor, and their roles, follows. First, a member of an organization's legal team such as a paralegal may define the entities to be monitored for a given monitor, and, following creation of the monitor, may view any changes in the monitor (e.g., action status changes). An IT administrator may create, view, edit, and manage the monitor. An action recipient may receive tasks and notifications outputted by the monitor. After completing a task, the action recipient may update the status of that task to reflect its completion. Finally, a system administrator may configure user access and privileges to application 300—for example, the administrator may allow certain users, groups, and/or roles to access select features of the application while blocking them from other features.

FIGS. 3A-3P particularly illustrate an exemplary monitor creation process. As shown in FIG. 3A, a variety of information regarding the monitor creator may be specified, as well as optional approvers, a description of the monitor, and information regarding the event to be monitored.

FIG. 3B shows examples of events that may be monitored, including events associated with custodians as well as custodian data sources.

FIG. 3C shows examples of entity parameters that may be tracked. The entity parameters may be accessed from HR store 114 and/or entity manager 122, for example.

FIG. 3D illustrates how conditions may be specified that control whether subsequently-defined actions execute. Condition specification in this example includes specification of one or more entities, parameters, operators, and values. One or more conditions may be specified.

FIG. 3E shows examples of entities that may be monitored. Other entity possibilities are within the scope of the disclosure.

FIGS. 3F-I show examples of custodian parameters that may be defined.

FIG. 3J shows examples of custodian data source parameters that may be defined.

FIG. 3K shows examples of matter parameters that may be defined.

FIG. 3L shows examples of matter custodian parameters that may be defined. A “matter custodian” as used herein refers to a custodian who is associated with a given matter. For example, the matter custodian may possess ESI relating to the matter on his or her computing device.

FIG. 3M shows examples of legal hold parameters that may be defined.

FIG. 3N shows examples of legal hold custodian parameters that may be defined. A “legal hold custodian” as used herein refers to a custodian who is associated with a legal hold.

FIG. 3O shows examples of interview parameters that may be defined.

FIG. 3P shows examples of interview custodian parameters that may be defined. An “interview custodian” as used herein refers to a custodian who is associated with an interview.

FIG. 3Q shows an example of an action menu. In this example, a plurality of actions has already been defined for the monitor. The existing actions may be modified or deleted, while new actions may be added. The actions may further be searched.

FIG. 3R shows an example of an action description menu that summarizes the contents of a particular task. Similar description menus may be provided for notifications and automated processes.

FIG. 3S shows an example of an action dropdown menu operable to add actions—namely, tasks, notifications, or automated processes (shown in the figure as “automated action”).

FIG. 3T-V show an example of an add task menu operable to add a task.

FIGS. 3W-Y show an example of an add notification menu operable to add a notification.

FIGS. 3Z-AB show an example of an add automated process menu operable to add an automated process.

FIG. 3AC illustrates how the monitor may be scheduled.

FIGS. 3AD-H show aspects of an exemplary monitor console.

FIG. 3AI shows an example menu operable to view mapped ESI associated with a custodian.

It will be appreciated that the aspects of application 300 illustrated in FIGS. 3A-AI are provided as examples and are not intended to be limiting in any way. Numerous additions, subtractions, and modifications are possible without departing from the scope of this disclosure.

It will be appreciated that the configurations disclosed herein are exemplary in nature, and that these specific embodiments are not to be considered in a limiting sense, because numerous variations are possible. The subject matter of the present disclosure includes all novel and nonobvious combinations and subcombinations of the various configurations, and other features, functions, and/or properties disclosed herein.

Note that the example systems and programs described herein may represent various acts, operations, or functions, each of which may be performed in the sequence described, in parallel, or in some cases omitted. Likewise, the order of processing is not necessarily required to achieve the features and advantages of the example embodiments described herein, but is provided for ease of illustration and description. One or more of the described program actions, operations, and/or functions may represent code to be programmed into a non-transitory computer readable storage medium in enterprise management system 118.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application.

1. A management system, comprising:
a logic subsystem; and
a storage subsystem holding instructions executable by the logic subsystem to:
create an entity monitor based on user input, the input comprising a designation of an entity, at least one parameter associated with the entity, and at least one condition that defines a change in the at least one parameter;
detect the change in the at least one parameter by accessing a storage device holding the at least one parameter; and
responsive to detecting the change in the least one parameter, record the change in the at least one parameter in the entity monitor and execute one or more actions defined by the user input.

2. The management system of claim 1, wherein the storage device is a human resource store communicatively coupled to the management system via network.

3. The management system of claim 1, wherein the entity is a custodian, the at least one parameter including an employment status of the custodian.

4. The management system of claim 3, wherein the at least one condition defines the employment status becoming equal to terminated.

5. The management system of claim 4, wherein the one or more actions include copying data associated with the custodian to a storage device, the data prevented from being deleted or otherwise modified at the storage device.

6. The management system of claim 5, wherein the one or more actions include removing irrelevant data and duplicate files.

7. The management system of claim 5, wherein the data is mapped by a data mapping module of the management system.

8. The management system of claim 1, wherein the one or more actions include assigning a task to one or more assignees, the instructions being further executable to change an action status of the entity monitor to completed upon completion of the task by the one or more assignees.

9. The management system of claim 1, wherein the one or more actions include automatically issuing an interview to one or more custodians.

10. The management system of claim 1, wherein the one or more actions include outputting a notification to a user indicating detection of the change in the at least one parameter.

11. A management system, comprising:
memory; and
at least one processor in communication with the memory, the memory comprising instructions executable by the at least one processor to:
retrieve from a human resource store a plurality of employment statuses associated with respective custodians; and
responsive to an employment status of the plurality of employment statuses changing relative to a previous retrieval of that employment status, preserve ESI associated with a custodian having the changed employment status.

12. The management system of claim 11, wherein the instructions are further executable to create a data map of ESI stored on one or more computing devices communicatively coupled to the management system via a network, the data map created via a data mapping module of the management system by accessing the one or more computing devices via the network.

13. The management system of claim 12, wherein preserving the ESI associated with the custodian having the changed employment status includes copying data from one or more computing devices associated with the custodian to an ESI vault, data stored on the ESI vault prevented from being deleted or modified, the data from the one or more computing devices selected based on the data map.

14. The management system of claim 11, wherein the instructions are further executable to, responsive to the employment status of the plurality of employment statuses changing relative to the previous retrieval of that employment status, issue an interview to one or more organizational superiors of the custodian having the changed employment status.

15. The management system of claim 14, wherein the interview is issued on a date retrieved from an entity profile associated with the custodian having the changed employment status, the entity profile stored in an entity manager of the management system, the entity profile updated by retrieving data from the human resource store.

16. The management system of claim 11, wherein the plurality of employment statuses are retrieved according to one or more of satisfaction of one or more user-defined conditions, a user-defined schedule, user initiation, and synchronization with the human resource store.

17. The management system of claim 11, wherein preserving the ESI associated with the custodian having the changed employment status includes preventing deletion and modification of email associated with the custodian on an email server.

18. A method, comprising:
create an entity monitor based on user input, the input comprising a designation of an entity, at least one parameter associated with the entity, and at least one condition that defines a change in the at least one parameter;
detect the change in the at least one parameter by accessing a storage device holding the at least one parameter; and
responsive to detecting the change in the least one parameter, record the change in the at least one parameter in the entity monitor and execute one or more actions defined by the user input.

19. The method of claim 18,
wherein the entity is a custodian;
wherein the at least one parameter is an employment status associated with the custodian,
wherein the at least one condition defines the change in the employment status becoming equal to terminated,
wherein the storage device is a human resource store holding a plurality of employment statuses associated with respective custodians, and
wherein the one or more actions include preventing deletion and modification of data associated with the custodian, outputting via email an interview to one or more organizational superiors of the custodian, and outputting via email an indication to the one or more organizational superiors indicating prevention of the deletion and modification of the data associated with the custodian.

20. The method of claim 19,
wherein the entity is a custodian,
wherein the at least one parameter is a status of a data source associated with the custodian,
wherein the at least one condition defines the change in the status of the data source becoming equal to modified,
wherein the storage device stores a data map mapping a plurality of custodian data sources, and
wherein the one or more actions include issuing an interview to the custodian, issuing a request to the custodian to update the data map, and outputting via email an indication to one or more organizational superiors of the custodian indicating change in the status of the data source, the method further comprising updating an action status of the entity monitor to completed upon a completed interview and a completed request from the custodian.
